(19) United States
(12) Patent Application Publication
(10) Pub. No.: US 2025/0367935 A1
(43) Pub. Date: Dec. 4, 2025

(54) INK CONTAINER AND INK JET PRINTING APPRATUS

(71) Applicant: CANON KABUSHIKI KAISHA, Tokyo (JP)

(72) Inventor: TOMOKI MORIKAWA, Tokyo (JP)

(21) Appl. No.: 19/215,522

(22) Filed: May 22, 2025

(30) Foreign Application Priority Data
May 31, 2024 (JP) 2024-089083

(51) Int. Cl. B41J 2/175

(52) U.S. Cl. CPC B41J 2/17513; B41J 2/17553; B41J 2002/17516; B41J 2/17559

(57) ABSTRACT

Provided is a technique of disassembling an ink pack into a single material and improving the recyclability. That is, the technique may contribute to realization of a sustainable society such as a decarbonized/recycling society. To this end, an ink container configured to contain an ink includes: a first container configured to contain the ink; and an ink supply unit joined to the first container and configured to supply the ink in the first container to outside of the ink container, in which the first container and the ink supply unit are adhered to each other via an adhesive in each adhesion region.

### BACKGROUND

### Field

The present disclosure relates to an ink container and specifically relates to an ink container formed by adhering a film of an ink containing unit to an ink supply unit.

### Description of the Related Art

There has been known an ink pack as an aspect of an ink container. For example, an ink pack disclosed by Japanese Patent Laid-Open No. 2022-020182 includes an internal pack that contains an ink, an ink supply unit welded to the internal pack, and an external pack that can contain the internal pack. The above-described ink pack can be reused by separating the ink supply unit, the internal pack, and the external pack from each other after use. This is favorable to reuse (recycle) a recycled plastic material to respond to a demand and the like for realization of a sustainable society such as a decarbonized/recycling society.

However, since the above-described ink pack is formed by welding the internal pack to the ink supply unit, an ink supply unit material and an internal pack material are compatible at a welding portion. For this reason, a boundary between the ink supply unit and the internal pack is unclear, which makes it difficult to separate the ink supply unit and the internal pack from each other at the boundary (an interface) in a case of the separation, and additionally, in some cases, the ink supply unit material and the internal pack material are likely to be separated in a mixed state at an adhesion portion in a case of the separation. As a result, there is a problem that the recyclability of the ink pack is reduced.

### SUMMARY

An object of the present disclosure is to provide an ink container that allows for separation between an ink supply unit and an ink container configuration material with high recyclability.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view of an ink ejection apparatus in a first embodiment;

FIG. 2 is a schematic perspective view of an ink pack in the first embodiment;

FIG. 3 is an exploded perspective view of the ink pack in the first embodiment;

FIG. 4 is an adhesion region diagram of the ink pack in the first embodiment;

FIGS. 5A to 5C are a top view, an adhesion region cross-sectional view, and a cross-sectional view of the ink pack in the first embodiment;

FIG. 6 is a perspective view of the ink pack in a second embodiment;

FIGS. 7A and 7B are a perspective view and an adhesion region cross-sectional view of the ink pack in a third embodiment;

FIGS. 8A to 8F are detail views of the ink pack in the third embodiment;

FIGS. 9A to 9D are an adhesion region cross-sectional view, a top surface cross-sectional view, and a detail view of the ink pack in a fourth embodiment; and

FIGS. 10A to 10D are detail views of the ink pack in the fourth embodiment.

### DESCRIPTION OF THE EMBODIMENTS

Embodiments are described below in detail with reference to the appended drawings. Note that, the following embodiments are not intended to limit the disclosure according to the scope of claims. Although multiple characteristics are described in the embodiments, not all the multiple characteristics are necessarily required for the disclosure, and the multiple characteristics may be combined to each other arbitrarily. Additionally, in the appended drawings, the same or similar configurations are provided with the same reference numerals, and duplicated descriptions may be omitted.

### First Embodiment

An embodiment of the technique of the present disclosure is described below with reference to the drawings. Note that, the following embodiment is not intended to limit the invention according to the scope of claims, and not all the combinations of the characteristics described in the present embodiment are necessarily required for the means for solving the problems of the invention.

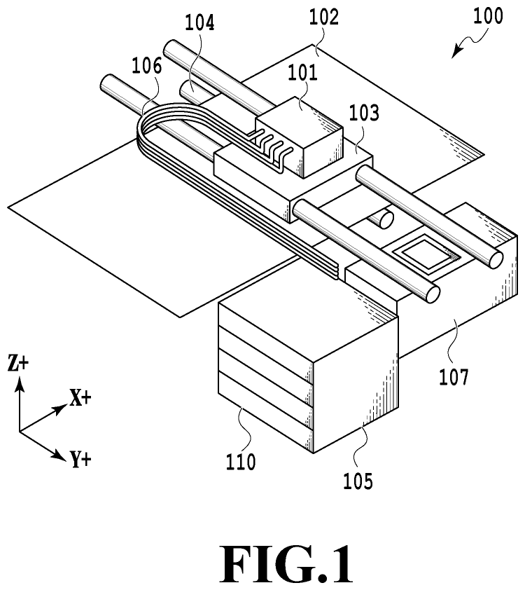

FIG. 1 is a schematic perspective view of an ink jet printing apparatus 100 according to the present embodiment. As illustrated in FIG. 1, the ink jet printing apparatus 100 includes an ink ejection head 101, a printing sheet 102, a carriage 103, a conveyance roller 104, an ink supply part 105, an ink supply tube 106, and a recovery unit 107.

The ink jet printing apparatus 100 repeats reciprocal movement (main scanning) of the ink ejection head 101 and conveyance (sub scanning) of the printing sheet 102 as a printing medium by a predetermined amount. In synchronization with the movements, the ink ejection head 101 selectively ejects multiple colors of inks and shoots the inks on the printing sheet 102 as the printing medium to print a character, a sign, an image, and so on. An example of the ink jet printing apparatus 100 includes an ink jet printer, for example. The printing medium may be, for example, various materials and forms such as paper, cloth, an optical disc label surface, a plastic sheet, an OHP sheet, and an envelope.

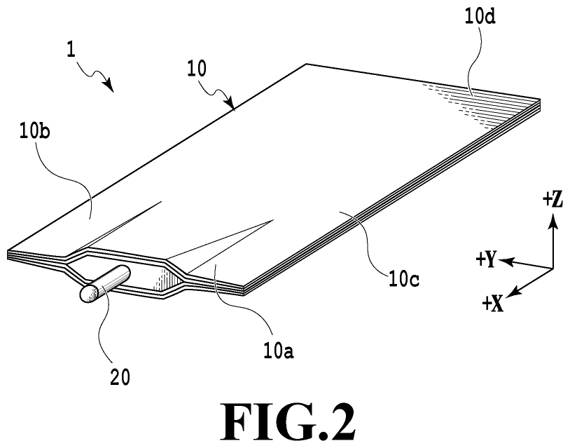

The ink ejection head 101 is mounted on the carriage 103 that is slidably supported by two guide rails and reciprocally moves on a straight line along the guide rails by a driving unit such as a motor (not illustrated). The printing sheet 102 is conveyed in a direction crossing a movement direction of the carriage 103 by the conveyance roller 104 as a conveyance unit while facing an ink ejection surface of the ink ejection head 101. The ink ejection head 101 includes multiple nozzle arrays to eject different colors of inks as multiple ink ejection units. Corresponding to the colors of inks ejected from the ink ejection head 101, multiple independent ink packs 1 (see FIG. 2) including an ink derivation member to derive the ink are mounted in the ink supply part 105. In the present embodiment, four ink packs 1 containing inks of cyan (C), magenta (M), yellow (Y), and black (K), respectively, are mounted in the ink supply part 105. The four ink packs 1 are the same size; however, for example, the ink pack 1 of the black ink may be greater than the ink packs 1 of the other colors of inks. Additionally, as a mode of the mounting of the ink ejection head 101 on the carriage 103, a configuration that allows for easy attachment and detachment may be applied, or a configuration of fixed arrangement may be applied.

The ink supply part 105 and the ink ejection head 101 are connected by multiple ink supply tubes 106 corresponding to the respective colors of inks. With the ink pack 1 (see FIG. 2) being mounted inside the ink supply part 105, it is possible to independently supply each color of ink contained in the ink pack 1 to the corresponding nozzle array of the ink ejection head 101. In a non-printing region, which is within a reciprocal movement range of the ink ejection head 101 and out of a passing range of the printing sheet 102, the recovery unit 107 is arranged to face the ink ejection surface of the ink ejection head 101.

The recovery unit 107 includes a cap unit to cap the ink ejection surface of the ink ejection head 101, a suction mechanism to forcibly suck the ink while capping the ink ejection surface, a cleaning blade to wipe off the smear of the ink ejection surface, and the like. The above-described suction operation is performed by the recovery unit 107 in advance to a printing operation of the ink jet printing apparatus 100. Thus, even in a case where the ink jet printing apparatus 100 is operated after a long period of inactivity, it is possible to eliminate remaining air bubbles in the ink ejection head 101 and thickened ink near an ejection port or either one of those by performing recovery processing by the recovery unit 107. Thus, ejection characteristics of the ink ejection head 101 are maintained. As above, the ink jet printing apparatus 100 has a function of introducing the ink from the ink pack 1 and ejecting the ink.

FIG. 2 is a perspective view schematically illustrating a configuration of the ink pack 1 (an ink container) in the present embodiment. Referring to FIG. 2, the ink pack 1 includes a flexible ink containing unit 10 that contains the ink and an ink supply unit 20 that supplies the contained ink to the outside of the container. In the present embodiment, the ink supply unit 20 is configured to supply the ink to the ink jet printing apparatus 100 and is provided with a check valve to prevent backflow of the liquid from the outside to the inside of the ink supply unit 20. The ink containing unit 10 includes an end portion 10a on an ink supply unit 20 side, end portions 10b and 10c of side surfaces, and an end portion 10d opposite to the end portion 10a. The ink containing unit 10 may be a pillow type bag that is formed by joining two films or may be a gusset type including a gusset in a side surface portion formed by folding and joining one film. The present embodiment relates to the shape of the pillow type.

Here, illustrated directions are described below. In the present specification, a longitudinal direction of the ink pack 1 is referred to as an X direction (a length direction), a plane direction orthogonal to the length direction is referred to as a Y direction (a width direction), and a direction orthogonal to the X and Y directions is referred to as a Z direction (a thickness direction). As for the X direction, a direction toward a side on which the ink pack 1 is mounted in the ink supply part 105 is a +X direction. As for the Y direction, a direction toward a left side viewed from a direction on a side on which the ink pack 1 is mounted in the ink supply part 105 is a-Y direction.

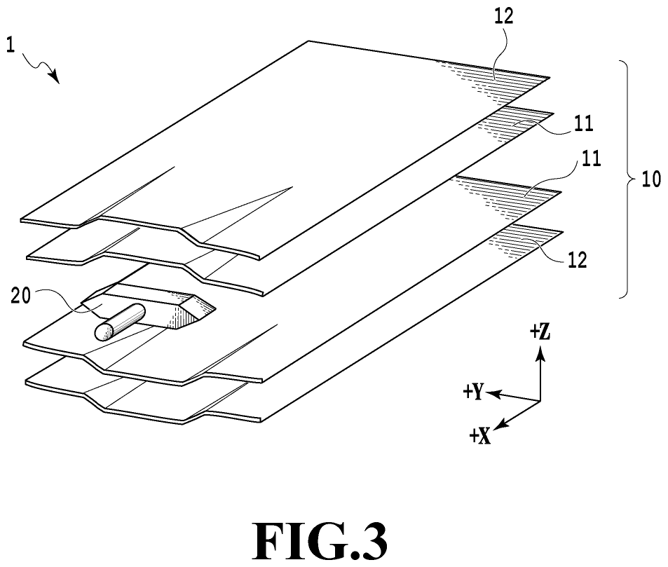

FIG. 3 is an exploded perspective view of the ink pack 1 in the present embodiment. In the present embodiment, the ink containing unit 10 is formed of a first film 11 and a second film 12 in a rectangular shape. The first film 11 and the second film 12 are materials having flexibility. The first film 11 is a film having a water vapor barrier property and a gas barrier property, which is nylon, polyethylene, polypropylene, polyethylene terephthalate (PET), polyvinyl chloride, polystyrene, or the like, for example. The second film 12 is a film having a shock resistance and durability, which is polyethylene terephthalate (PET), nylon, or the like, for example.

In the present embodiment, the first film 11 is a film including polyethylene having the water vapor barrier property, and the second film 12 is a film including polyethylene terephthalate (PET) having the shock resistance. With the above-described configuration, it is possible to secure the gas barrier property of the ink pack 1 and maintain the density and the quality of the ink.

The first film 11 and the second film 12 may be a composite film formed of multiple materials, but are preferably formed of a single material in terms of recycling. The single material indicates a film containing a single resin of a content of 90% or more as a component of the film. In order to secure the gas barrier property, an aluminum vapor-deposited layer may be arranged on a surface of the first film 11 facing the second film 12 or a surface of the second film 12 facing the first film 11.

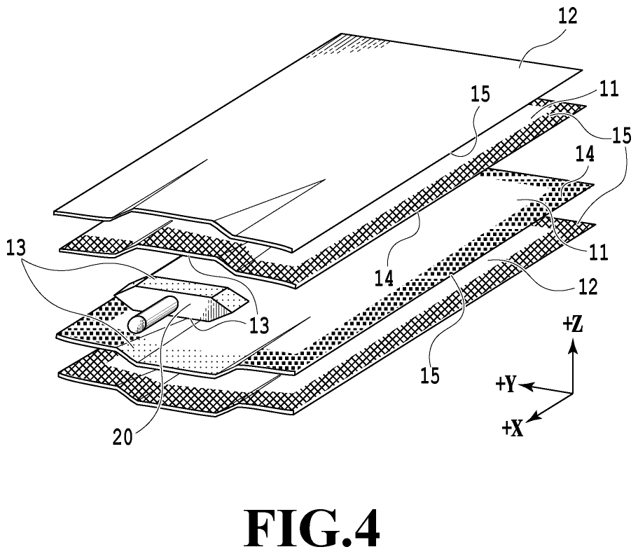

FIG. 4 is a perspective view illustrating an adhesion region of the ink pack 1. A first adhesion region 13 is an adhesion region between the first film 11 and the ink supply unit 20. That is, in the present embodiment, the ink supply unit 20 and the first film 11 inside the container are adhered to each other by an adhesive. A second adhesion region 14 is in an outer periphery portion between the two first films 11, which is an adhesion region in the outer periphery portion between the two first films 11 except the first adhesion region 13. Accordingly, the first adhesion region 13 and the second adhesion region 14 are positioned in the outer periphery portion between the two first films 11. A third adhesion region 15 is an adhesion region that is positioned in an outer periphery portion between the first film 11 and the second film 12.

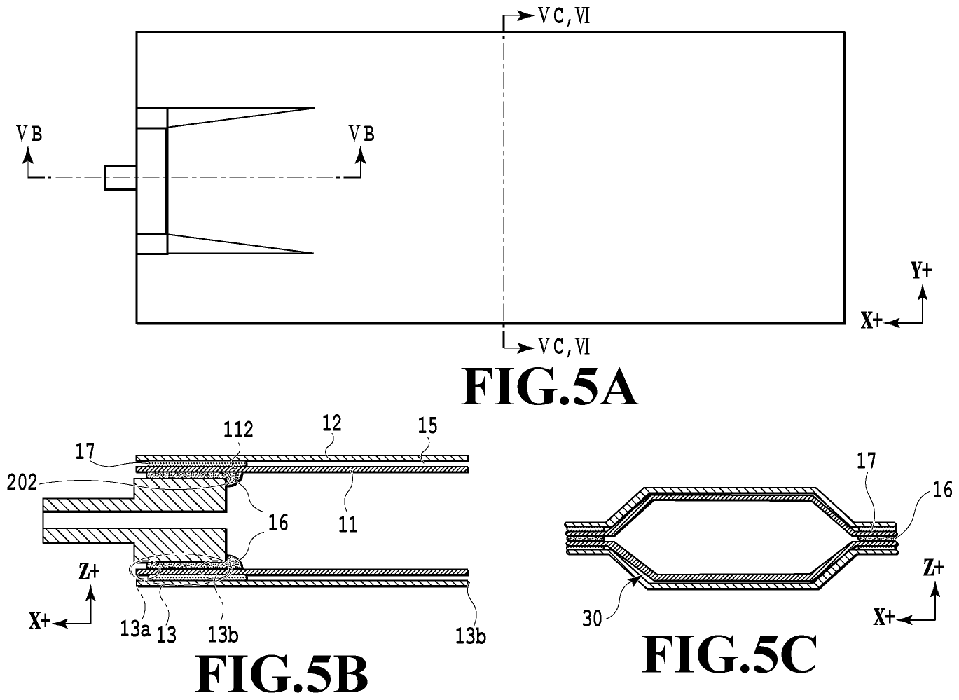

FIG. 5A is a top view of the ink pack 1, FIG. 5B is a cross-sectional view taken along an VB-VB line in FIG. 5A, and FIG. 5C is a cross-sectional view taken along a VC-VC line in FIG. 5A. As illustrated in FIG. 5B, a first adhesive 16 is applied to the first adhesion region 13, and the ink supply unit 20 and the first film 11 are adhered to each other. The first adhesion region 13 includes an outer adhesion region 13a on an outer side of an ink supply direction and an inner adhesion region 13b on an inner side. With this configuration, a position and/or an amount of application of the first adhesive 16 are determined so as to protrude out of the inner adhesion region 13b between the ink supply unit 20 and the first film 11 to the inside of the ink containing unit.

With the first adhesive 16 protruding out of the inner adhesion region 13b as described above, a layer of the first adhesive 16 is also formed on a surface 202 of the ink supply unit 20 and a surface 112 of the first film 11, and the first film 11 and the ink supply unit 20 are joined to each other via the surface 202 and the surface 112. Thus, the ink supply unit 20 and the first film 11 are joined to each other via not only the first adhesion region 13 but also the surface 202 and the surface 112, and the adhesion strength is improved.

Additionally, in a case where the first adhesive 16 protrudes out of the inner adhesion region 13b, a surface area of the first adhesive 16 that is put in contact with the ink is increased. Thus, force applied from the ink to the first adhesive 16 is dispersed, and the applied pressure is reduced. According to the above-described points, with the first adhesive 16 protruding out of the inner adhesion region 13b, the adhesion strength between the ink supply unit 20 and the first film 11 is improved, and it is possible to hold the ink stably. The first adhesive 16 is an adhesive having ink resistance, which is thermosetting type epoxy resin adhesive or the like, for example.

The first adhesive 16 is arranged in the second adhesion region 14 in the outer periphery portion between the two first films 11, the outer periphery portion between the two first films 11 is adhered, and a first pack 30 (a first container) in the form of a bag to contain the ink is formed.

A second adhesive 17 is arranged in the third adhesion region 15, and the first film 11 and the second film 12 are adhered to each other. The third adhesion region 15 may be entire surfaces facing each other between the first film 11 and the second film 12; however, in a case where the third adhesion region 15 is only a part or only the outer periphery portion between the first film 11 and the second film 12, it is possible to easily separate the first film 11 and the second film 12 from each other.

According to the ink pack 1 of the present embodiment described above, the boundary (the interface) of joining between the ink supply unit 20 and the first film 11 and the boundary (the interface) of joining between the first film 11 and the second film 12 are clear, and the separation is easily performed by applying force to the interface in a case of the separation. Additionally, with the separation, the material of each of the ink supply unit 20 and the first film 11 is not mixed to the separated other material. As a result, it is possible to obtain an ink pack with high recyclability.

Moreover, since the first adhesive 16 protrudes to an inner adhesion region 13b side, it is possible to improve the strength against the pressure of the ink while maintaining the separability from an outer adhesion region 13a side.

The first adhesive 16 and the second adhesive 17 are a thermosetting type epoxy resin adhesive, a moisture-curable type silicone adhesive, or the like with a viscosity of 200° C. or smaller or a contact angle of 45° or greater that achieves easy application. Additionally, the first adhesive 16 and the second adhesive 17 may have a melting point of 200° C. or lower, and in this case, the first adhesive 16 and the second adhesive 17 may be broken down by peeling off the adhesion region while heating. Moreover, also in a case where the aluminum vapor-deposited layer is formed on the first film 11 and the second film 12, it is possible to eliminate the vapor-deposited layer by performing alkali washing after the film is disassembled, and it is possible to improve the recyclability of the film.

### Second Embodiment

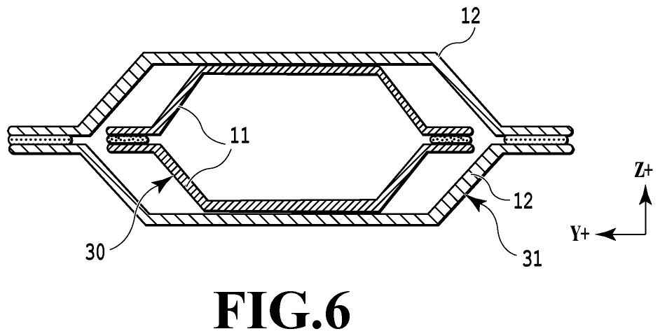

FIG. 6 is a cross-sectional view of the ink pack 1 in a second embodiment and illustrates a cross-section taken along the VI-VI line illustrated in FIG. 5A, similar to FIG. 5B according to the first embodiment. A different point from the first embodiment is that the two second films 12 form a second pack 31 (a second container), and the first pack 30 is arranged inside the second pack 31. In this case, in the third adhesion region 15 between the first film 11 and the second film 12, only an end portion 10a side of the ink containing unit 10 illustrated in FIG. 2 is adhered. With this configuration, the adhesion region between the first film 11 and the second film 12 is reduced, and the separation is easy.

### Third Embodiment

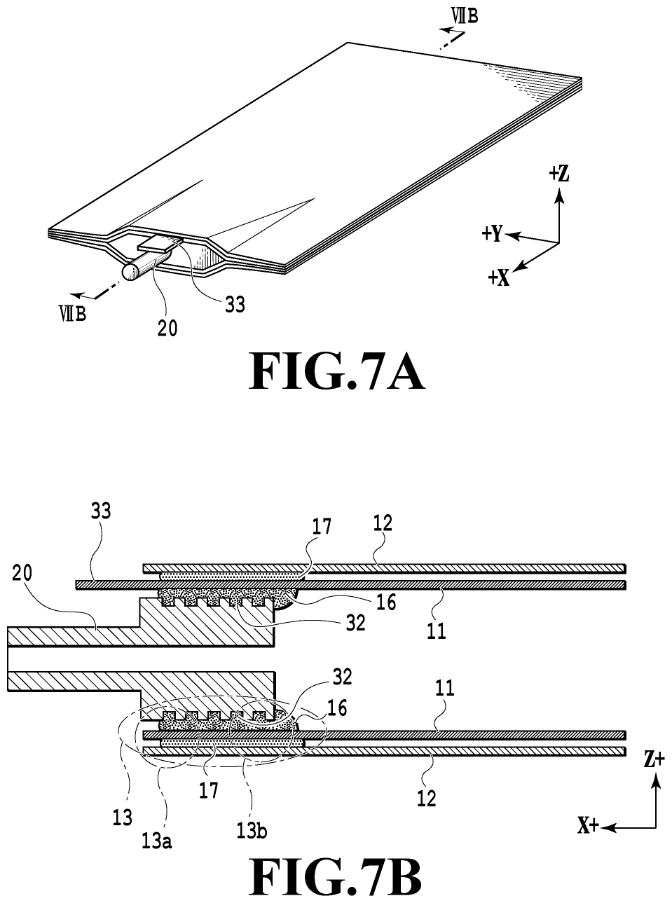

FIG. 7A is a perspective view of the ink pack in a third embodiment of the present disclosure, and FIG. 7B is a cross-sectional view taken along a VIIIB-VIIIB line in FIG. 7A. In the third embodiment, an uneven portion 32 is provided in the first adhesion region 13 of the ink supply unit 20. The shape of the uneven portion 32 is an irregular shape that is a combination of rectangle, arc, and the like. The uneven portion 32 can increase a contact area of the adhesive in the ink supply unit 20, and it is possible to improve the adhesion strength and the adhesiveness between the first film 11 and the ink supply unit 20.

Additionally, as illustrated in FIG. 7B, the first film 11 extends toward the outer adhesion region 13a side to provide a gripping portion 33. The gripping portion 33 has a length of about 5 mm to 30 mm in the X direction from an end on the outer adhesion region 13a side. With this configuration, it is possible to separate the first film 11 and the second film 12 from each other with greater force by gripping the gripping portion 33 in a case of disassembling the ink pack 1 and applying the force in a +Z direction or a −X direction. With this configuration, it is possible to improve the separability while also improving the adhesiveness.

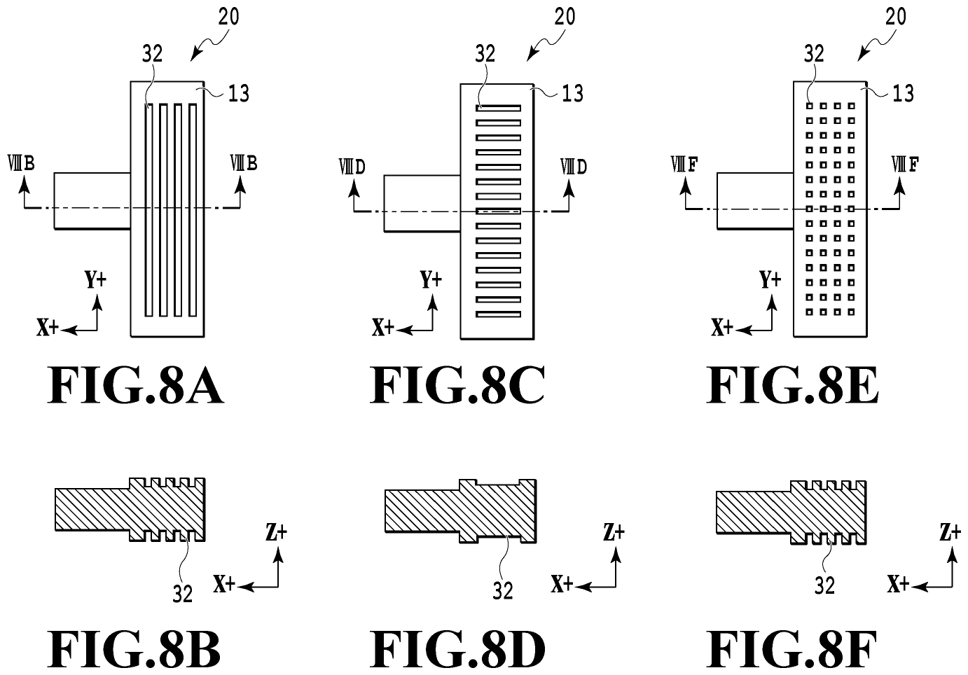

FIGS. 8A to 8F are diagrams each illustrating a mode of the uneven portion 32. The mode illustrated in FIGS. 8A and 8B are formed with a recess portion of the uneven portion 32 extending in the Y direction as a groove in the first adhesion region 13 and the multiple extending grooves being arrayed in the direction of supplying the ink (the X direction). The mode illustrated in FIGS. 8C and 8D are formed with the recess portion of the uneven portion 32 extending in the X direction as a groove in the first adhesion region 13 and the multiple grooves being arrayed in the Y direction. The mode illustrated in FIGS. 8E and 8F are formed with the recess portion of the uneven portion 32 being arrayed in the X and Y directions as a groove having a rectangular shape. The mode of the uneven portion 32 illustrated in FIGS. 8E and 8F can have a greater adhesion surface area than that in FIGS. 8A to 8D within the same area.

### Fourth Embodiment

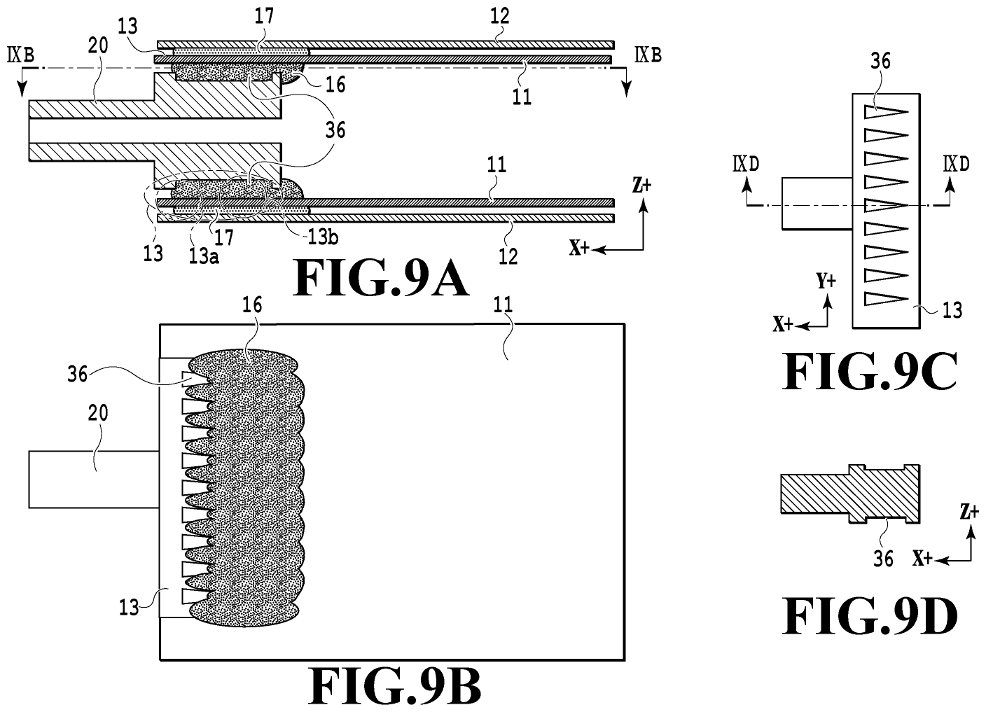

FIG. 9A is a cross-sectional view illustrating an adhesion mode between the ink supply unit 20 and the first film 11 of the ink pack 1 according to a fourth embodiment of the present disclosure. FIG. 9B is a cross-sectional view taken along a IXB-IXB line in FIG. 9A, and FIG. 9C is a top view of the ink supply unit 20 and FIG. 9D is a cross-sectional view taken along an IXD-IXD line in the FIG. 9C. In the fourth embodiment, a clearance groove 36 is provided in the first adhesion region 13 of the ink supply unit 20. As illustrated in FIG. 9C, the clearance groove 36 has a groove width that narrows toward the −X direction, and a depth of the groove has a constant shape.

In the present embodiment, the first adhesive 16 is applied to the ink supply unit 20 including the clearance groove 36. With the first film 11 and the ink supply unit 20 being adhered to each other, a great amount of the adhesive enters the clearance groove 36 on the outer adhesion region 13a side, and spread of the adhesive is suppressed between the ink supply unit 20 and the first film 11. On the other hand, a small amount of the adhesive enters the clearance groove 36 on the inner adhesion region 13b side, and spread of the adhesive is not suppressed between the ink supply unit 20 and the first film 11. Thus, the adhesion area on the outer adhesion region 13a side is smaller than that on the inner adhesion region 13b side, and a difference occurs in the adhesion strengths. As a result, the adhesion strengths on the inner adhesion region 13b side and the outer adhesion region 13a side are maintained well. Additionally, it is possible to make the adhesion strength on the outer adhesion region 13a side smaller than the adhesion strength on the inner adhesion region 13b side, and it is possible to improve the separability in a case of pulling the first film 11 from the outer adhesion region 13a side to separate.

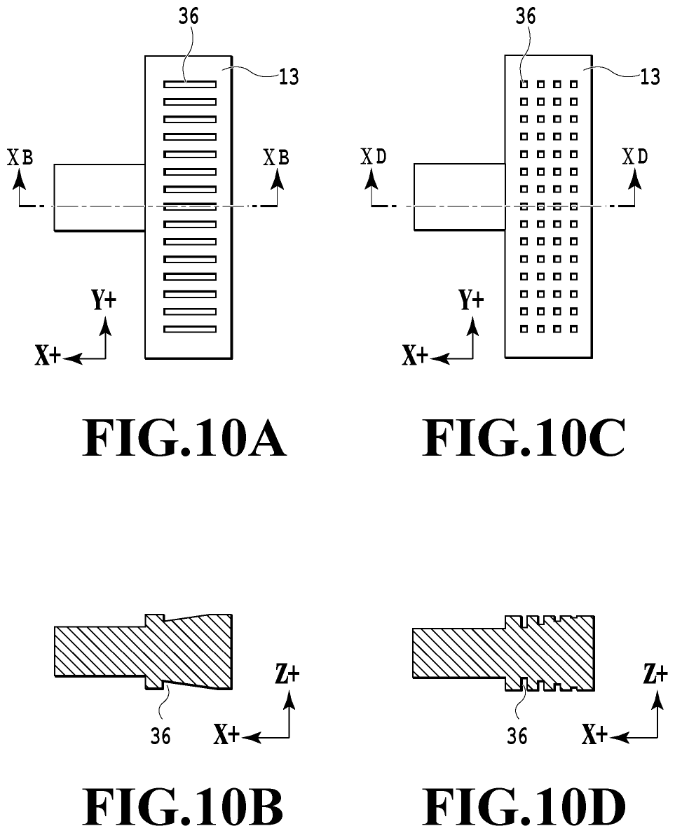

FIGS. 10A to 10D each illustrate another mode of the clearance groove 36. A clearance groove illustrated in FIGS. 10A and 10B has a shape in which a depth of the clearance groove 36 (the Z direction) becomes continuously shallow from the outer adhesion region 13a side toward the inner adhesion region 13b side. A clearance groove illustrated in FIGS. 10C and 10D has a form in which the depth of the clearance groove 36 that is two-dimensionally arrayed in the adhesion region 13 becomes shallow from the outer adhesion region 13a side toward the inner adhesion region 13b side.

The clearance groove 36 illustrated in FIGS. 10A and 10B has a constant area along the X direction on an XY plane; for this reason, it is possible to control the protrusion amount even in a case where the amount of the used first adhesive 16 is small. The clearance groove 36 illustrated in FIGS. 10C and 10D can easily increase the amount of the clearance groove 36 within the same area; for this reason, it is possible to have also the function of the uneven portion 32 that increases the contact area between the first adhesive 16 and the ink supply unit 20 and improves the adhesiveness.

Both the first film 11 and second film 12 may be a single material; however, only either one may be a single material. In order to improve the adhesiveness of the first film 11, the second film 12, and the ink supply unit 20, a primer may be applied to the first adhesion region 13, the second adhesion region 14, and the third adhesion region 15. Additionally, a surface roughness of the first film 11, the second film 12, and the ink supply unit 20 may be increased.

Note that, the technique described in the present specification may contribute to the realization of a sustainable society such as a decarbonized/recycling society.

According to the present disclosure, it is possible to achieve separation between an ink supply unit and an ink container configuration material with high recyclability in an ink container.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-089083, filed May 31, 2024, which is hereby incorporated by reference herein in its entirety.

What is claimed is:

1. An ink container configured to contain an ink, comprising:
a first container configured to contain the ink; and
an ink supply unit joined to the first container and configured to supply the ink in the first container to outside of the ink container, wherein
the first container and the ink supply unit are adhered to each other via an adhesive in each adhesion region.

2. The ink container according to claim 1, wherein
the adhesive protrudes out of the adhesion region between the first container and the ink supply unit to inside of the first container.

3. The ink container according to claim 1, further comprising:
a second container, wherein
the first container is arranged inside the second container, and a part between the first container and the second container is adhered by an adhesive.

4. The ink container according to claim 3, wherein
the first container and the second container are a first pack and a second pack, respectively, which are in a form of a pack formed of a film of a single material.

5. The ink container according to claim 4, wherein
an aluminum vapor-deposited layer is included in either an outer side of the first pack or an inner side of the second pack.

6. The ink container according to claim 4, wherein
the first pack includes a gripping portion extending outward from the adhesion region between the first pack and the ink supply unit.

7. The ink container according to claim 6, wherein
the gripping portion has a length of 5 mm to 30 mm.

8. The ink container according to claim 4, wherein
the ink supply unit includes an uneven portion in the adhesion region between the ink supply unit and the first pack.

9. The ink container according to claim 8, wherein
the uneven portion is arranged along a direction from a side on which the ink is contained to a side on which the ink is supplied.

10. The ink container according to claim 8, wherein
the uneven portion is arranged orthogonally to a direction from a side on which the ink is contained to a side on which the ink is supplied.

11. The ink container according to claim 4, wherein
the ink supply unit includes a clearance groove portion in the adhesion region between the ink supply unit and the first pack.

12. The ink container according to claim 11, wherein
the clearance groove portion has a narrower width on a side on which the ink is contained than a width on a side on which the ink is supplied.

13. The ink container according to claim 11, wherein
the clearance groove portion has a shallower depth on a side on which the ink is contained than a depth on a side on which the ink is supplied.

14. The ink container according to claim 1, wherein
the adhesive is an adhesive having a melting point of 200° C. or lower.

15. An ink jet printing apparatus configured to perform printing by using an ink contained in an ink container, the ink container comprising:
a first container configured to contain the ink; and
an ink supply unit joined to the first container and configured to supply the ink in the first container to outside of the ink container, wherein
the first container and the ink supply unit are adhered to each other via an adhesive in each adhesion region.
